(19) United States
(12) Patent Application Publication
(10) Pub. No.: US 2024/0288599 A1
(43) Pub. Date: Aug. 29, 2024

(54) METHOD AND SYSTEM FOR SUBSURFACE IMAGING USING MULTI-PHYSICS JOINT MIGRATION INVERSION AND GEOPHYSICAL CONSTRAINTS

(71) Applicant: SAUDI ARABIAN OIL COMPANY, Dhahran (SA)

(72) Inventors: Taqi Yousuf Alyousuf, Sayhat (SA); Daniele Colombo, Dhahran (SA)

(73) Assignee: SAUDI ARABIAN OIL COMPANY, Dhahran (SA)

(21) Appl. No.: 18/174,494

(22) Filed: Feb. 24, 2023

(51) Int. Cl. G01V 1/28; G01V 1/50; G01V 11/00

(52) U.S. Cl. CPC G01V 1/282; G01V 1/50; G01V 11/002; G01V 2210/47; G01V 2210/6163; G01V 2210/6165; G01V 2210/6169; G01V 2210/6222; G01V 2210/665

(57) ABSTRACT

A method may include obtaining seismic data for a geological region of interest. The method may further include obtaining geophysical data for the geological region of interest. The method may further includes determining various pressure wavefields using a slowness model and a reflectivity model. The method may further include determining various slowness gradients for the slowness model based on the geophysical data, the pressure wavefields, the seismic data, and a geophysical constraint. The geophysical constraint may correspond to an objective function that determines a misfit between the geophysical data and the slowness model. The method may further includes updating the slowness model using the slowness gradients to produce an updated slowness model. The method may further include generating, based on the updated slowness model and the reflectivity model, a subsurface image of the geological region of interest.

### BACKGROUND

Various seismic processing operations are performed on seismic data from a survey to convert time-based seismic data into a depth representation of a subsurface. For example, seismic processing operations may include surface multiple filtering and other noise removal operations. Likewise, seismic processing may also include application of seismic inversion techniques and migration algorithms to velocity models.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining seismic data for a geological region of interest. The method further includes obtaining geophysical data for the geological region of interest. The method further includes determining, by a computer processor, various pressure wavefields using a slowness model and a reflectivity model. The method further includes determining, by the computer processor, various slowness gradients for the slowness model based on the geophysical data, the pressure wavefields, the seismic data, and a geophysical constraint. The geophysical constraint corresponds to an objective function that determines a misfit between the geophysical data and the slowness model. The method further includes updating, by the computer processor, the slowness model using the slowness gradients to produce an updated slowness model. The method further includes generating, by the computer processor and based on the updated slowness model and the reflectivity model, a subsurface image of the geological region of interest.

In general, in one aspect, embodiments relate to a system that includes a reservoir simulator that includes a computer processor. The reservoir simulator perform a method that includes obtaining geophysical data for the geological region of interest. The method further includes determining, by a computer processor, various pressure wavefields using a slowness model and a reflectivity model. The method further includes determining, by the computer processor, various slowness gradients for the slowness model based on the geophysical data, the pressure wavefields, the seismic data, and a geophysical constraint. The geophysical constraint corresponds to an objective function that determines a misfit between the geophysical data and the slowness model. The method further includes updating, by the computer processor, the slowness model using the slowness gradients to produce an updated slowness model. The method further includes generating, by the computer processor and based on the updated slowness model and the reflectivity model, a subsurface image of the geological region of interest.

In some embodiments, various pressure wavefields are determined using an updated slowness model and a reflectivity model. Various reflectivity gradients for the reflectivity model may be determined based on the pressure wavefields and seismic data. The reflectivity model may be updated using the reflectivity gradients to produce an updated reflectivity model. In some embodiments, a slowness model and a reflectivity model are alternately updated in an iterative process until the slowness model converges to a minimum. In some embodiments, various pressure wavefields include various upgoing pressure wavefields and various downgoing pressure wavefields. The pressure wavefields may be determined using a forward modeling function. In some embodiments, a determination is made whether a slowness model satisfies a predetermined criterion. The predetermined criterion may correspond to a first objective function and a second objective function. The first objective function may be based on a first misfit between acquired seismic data and synthetic seismic data corresponding to various pressure wavefields. The second objective function may be based on a second misfit between geophysical data and various geophysical properties associated with a slowness model. The slowness model may be updated in response to the slowness model failing to satisfy the predetermined criterion. In some embodiments, geophysical data includes electromagnetic data and gravity data. The electromagnetic data may be used to determine an electrical resistivity model for the geological region of interest. The gravity data may be used to determine a density model for the geological region of interest. A geophysical constraint may include a rock-physics constraint that provides an objective function based on a misfit between the slowness model, the electrical resistivity model, and the density model. In some embodiments, an electrical resistivity model is obtained for the geological region of interest using a portion of geophysical data. The portion of the geophysical data may include electromagnetic data this is acquired using a helicopter transient electromagnetic survey. A geophysical constraint may be a structural constraint based on a cross-gradient function that is performed between the slowness model and the electrical resistivity model. In some embodiments, a geophysical constraint is obtained that is a clustering constraint. Various geological objects may be determined based on geophysical data for the geological region of interest. Various clusters may be determined in a geological region of interest based on a statistical analysis of the geological objects. A determination may be made whether the slowness model satisfies the clustering constraint based on the clusters. A slowness model may be updated in response to the slowness model failing to satisfy the clustering constraint.

In some embodiments, various slowness gradients are determined based on a gradient descent method. In some embodiments, a presence of hydrocarbons are determined in a geological region of interest using a subsurface image. In some embodiments, seismic data regarding are acquired, using a seismic surveying system, for a geological region of interest.

In some embodiments, a gravity surveying system include an aircraft device and various gravity gradiometers. The gravity surveying system may generate gravity data for a geological region of interest. The gravity surveying system may be coupled to a reservoir simulator. Geophysical data may include the gravity data.

In some embodiments, a logging system includes a logging tool. The logging system may be coupled to a drilling system that drills a wellbore in a geological region of interest. The logging system may generate well log data using the logging tool. Geophysical data may include the well log data.

In some embodiments, an electromagnetic surveying system includes an aircraft device various electromagnetic sensors. The electromagnetic surveying system may generate electromagnetic data for a geological region of interest. The electromagnetic surveying system may be coupled to a reservoir simulator. Geophysical data may include the electromagnetic data.

In light of the structure and functions described above, embodiments disclosed herein may include respective means adapted to carry out various steps and functions defined above in accordance with one or more aspects and any one of the embodiments of one or more aspect described herein.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, and 3 show systems in accordance with one or more embodiments.

FIG. 4 shows a flowchart in accordance with one or more embodiments.

FIGS. 5A, 5B, 5C, 6, 7, 8A, 8B, 8C, 9A, 9B, 9C, 10A, 10B, 10C, and 10D show examples in accordance with one or more embodiments.

FIG. 11 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining subsurface images using a joint inversion process based on seismic data and other geophysical data. For example, other types of geophyical data may include electromagnetic data, gravity data, well log data, and/or core sample data. In some embodiments, a seismic data processing workflow is combined with various geophysical constraints to update a slowness model and a reflection model to match the actual geophysical properties of a geological region. Rather than only fitting acquired seismic data from a seismic survey to synthetic seismic data produced in the seismic inversion process, the updated models may also be analyzed iteratively using geophysical constraints. In particular, a geophysical constraint may be a type of objective function that uses two or more different types of geophysical data (e.g., seismic data, electromagnetic data, and/or gravity data) to determine whether geophysical properties of the updated models also satisfy an actual geological region. Thus, the joint inversion process may be performed until the slowness model and the reflection model both satisfy a predetermined criterion, such as model convergence or a predetermined number of iterations.

Furthermore, some embodiments include a multi-physics joint migration imaging (MpJMI) process that combines techniques from seismic joint migration inversion (JMI) and multi-physics inversion into a single inversion scheme. More specifically, a MpJMI process may determine a subsurface image and a velocity model using joint inversion techniques with various geophysical constraints. For example, an inversion process may be formulated as a constrained problem solved by minimizing multiple objective functions based on a data misfit between acquired and synthetic data as well as data misfits relating to inter-domain geophysical constraints. In some embodiments, for example, geophysical constraints include rock-physics constraints, structural constraints, and/or clustering constraints. In contrast to joint migration inversion using seismic data alone, a MpJMI process based on geophysical constraints may recover a subsurface image and velocity model closer to the true models for a geological region. Thus, MpJMI processes may derive both high resolution subsurface image and velocity models for geological regions that incorporate geophysical data from various geophysical surveying techniques, such as electromagnetic and gravity surveying methods.

Keeping with multi-physics joint migration imaging, MpJMI processes may also alleviate various difficulties encountered in seismic imaging using geophysical data that is independent of seismic data surveying. For example, electromagnetic (EM) data may have long-wavelength low-frequency information that describes the near subsurface and is not recoverable from the seismic data. As such, electromagnetic data may provide complementary information to seismic data for complex subsurfaces (e.g., subsalt layers or geological target formations located below deep covering limestone or basalt layers). However, the integration of seismic data and electromagnetic data into an inversion scheme may require specific geophysical constraints for use as coupling operators between these different data types.

In some embodiments, one or more MpJMI processes are based on full wavefield modeling. For example, a MpJMI process may not attempt to solve the wave equation's differential form directly. Instead, the MpJMI process may use various integral operators that evaluate different aspects of wave propagation in the subsurface. By forward modelling seismic data based on a background velocity model and whose reflection amplitudes depend on a reflectivity model of the subsurface, the MpJMI process may implement inversion scheme that determines a slowness model σ. Likewise, the MpJMI process may also determine a true amplitude reflectivity r of the subsurface to produce a reflectivity model. Thus, some inversion processes may be formulated as a constrained minimization problem that is solved by minimizing a particular objective function. In some embodiments, the objective function for a MpJMI process is expressed using the following equation:

$${ϕ}_{t} ( m , r , v , U ) = {ϕ}_{d} ( m , r ) + {λ}_{1} {ϕ}_{rp} ( m ) + {λ}_{2} {ϕ}_{fcm} ( m , v , U ) + {λ}_{3} {ϕ}_{st} ( m ) \qquad Equation 1$$

where m correspond to model property values in a geophysical model, r correspond to reflectivity values in the reflectivity model, v corresponds to various cluster centers for different geological objects, U corresponds to membership of geological objects in a particular cluster, ϕ_{d} corresponds to an objective function that measures a data misfit based on the difference between acquired seismic data and synthetic seismic data, ϕᵣₚ corresponds to a rock-physics constraint, ϕ_{fcm} corresponds to a clustering constraint (e.g., FCM clustering term), ϕₛₜ corresponds to a structural constraint, and λᵢ, i=1, . . . 3 are different Lagrange multipliers. The model vector m=[σ, ρ]^{T} corresponds to geophysical properties of a geophysical model, where σ and ρ correspond to P-wave slowness and electrical resistivity values, respectively. In some embodiments, the data misfit ϕ_{d} is expressed using the following equation:

$${ϕ}_{d} = \frac{1}{2} {\sum }_{shots} {\sum }_{ω} {‖ f ( D ( {z}_{0} ) - {P}^{-} ( {z}_{0} ) ) ‖}_{{L}_{2}}^{2} \qquad Equation 2$$

where D corresponds to acquired seismic data, such as a seismic shot record, P⁻ corresponds to synthetic seismic data, such as a forward modelled shot record, and ƒ corresponds to a frequency dependent weighting factor that may partially remove the wavelet imprint on the seismic data and biases the inversion process experiences toward lower frequencies. For example, it may be assumed that all amplitude effects in the geological medium are addressed based on the reflectivity model, while the slowness model may only affect the kinematics of wave propagation. Based on these assumptions, various forward modeling propagation operators P^{±} may be related to a slowness model. For example, propagation operators may be based on a recursive solution of the one-way wave equation. Thus, the basic continuation step that may be used to determine the wavefield at depth z+Δz using the wavefield at depth z can be expressed in the frequency-wavenumber domains using the phase shift operator. In some embodiments, for example, the forward modeling propagation operators are expressed using the following equation:

$${P}_{z + Δ z} ( ω , {k}_{x} , {k}_{y} ) = {P}_{z} ( ω , {k}_{x} , {k}_{y} ) {e}^{{ik}_{z} Δ z} \qquad Equation 3$$

where ω corresponds to the temporal frequency, kₓ and k_{y} correspond to the horizontal wavenumbers, and k_{z} corresponds to the vertical wavenumber. The vertical wavenumber k_{z} may be expressed by the following dispersion relation, which often is called the single square-root (SSR) equation:

$${k}_{z} = SSR ( ω , {k}_{x} , {k}_{y} ) = \sqrt{{ω}^{2} {σ}^{2} - ( {k}_{x}^{2} + {k}_{y}^{2} )} \qquad Equation 4$$

Returning to Equation 1, the rock-physics constraint ϕᵣₚ may be an objective function that quantifies the rock physics operator, p. For example, the rock-physics constraint may be based on electromagnetic data and related to electrical resistivity ρ to P-wave velocity V with a nonlinear function ƒᵣₚ. In some embodiments, a rock physics constraint ϕᵣₚ is expressed using the following equations:

$${ϕ}_{rp} ( m ) = {\sum }_{j = 1}^{{N}_{m}} {W}_{p} {\vert {p}_{j} \vert}^{2} = {‖ {W}_{p} p ‖}_{{L}_{2}}^{2} \qquad Equation 5$$

$${p}_{j} = {ρ}_{j} - {f}_{rp} ( {V}_{j} ) \qquad Equation 6$$

where Wₚ is a rock-physics weighting matrix.

Returning to Equation 1, an FCM clustering constraint ϕ_{fcm} may be a specific type of clustering constraint that is an objective function. The FCM clustering constraint may quantify a clustering operator ƒ, which allows model property values mⱼ=(vⱼ, ρⱼ)^{T} at the j^{th} grid location to belong to multiple cluster centers, i.e., v_{K}=[\tilde{v}_{K}, \tilde{ρ}_{K}]^{T}, with varying degrees of membership U through minimization of the following functional ƒⱼ. In some embodiments, an FCM clustering constraint is expressed using the following equations:

$${ϕ}_{fcm} ( m , v , U ) = {\sum }_{j = 1}^{{N}_{m}} {W}_{f}^{2} {\vert {f}_{j} \vert}^{2} = {‖ {W}_{f} f ‖}_{{L}_{2}}^{2} \qquad Equation 7$$

$${f}_{j} = {\sum }_{K = 1}^{C} {U}_{jK}^{q} {‖ {m}_{j} - {v}_{K} ‖}_{2}^{2} \qquad Equation 8$$

where C is a particular number of clusters, \tilde{v}_{K} is the K^{th} velocity cluster center, and \tilde{ρ}_{K} is the K^{th} resistivity cluster, and q≥1 is an exponent controlling the degree of fuzzy overlapping.

Finally, the structural constraint ϕₛₜ in Equation 1 may be an objective function that quantifies a cross-gradient x, by steering the recovered reflectivity model and slowness model to have structural similarity as a referenced model. In some embodiments, a structural constraint is expressed using the following equations:

$${ϕ}_{st} ( m ) = {\sum }_{j = 1}^{{N}_{m}} {W}_{st} {\vert {x}_{j} \vert}^{2} = {‖ {W}_{st} x ‖}_{{L}_{2}}^{2} \qquad Equation 9$$

$${x}_{j} = ▽ {v}_{j} \times ▽ {ρ}_{j} \qquad Equation 10$$

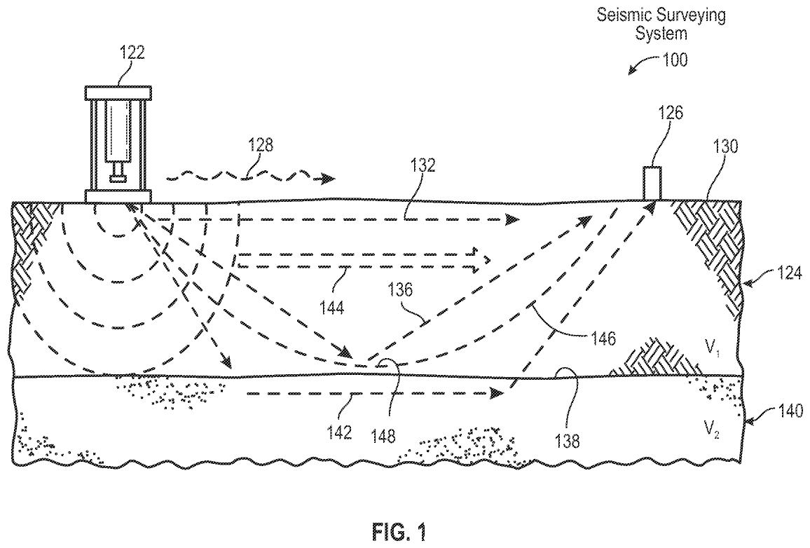

Turning to FIG. 1, FIG. 1 shows a schematic diagram in accordance with one or more embodiments. As shown in FIG. 1, FIG. 1 illustrates a seismic surveying system (100) and various resultant paths of pressure waves (also called seismic waves). The seismic surveying system (100) includes a seismic source (122) that includes functionality for generating pressure waves, such as a reflected wave (136), refracting wave (142), or diving wave (146), through a subsurface layer (124). Pressure waves generated by the seismic source (122) may travel along several paths through a subsurface layer (124) at a velocity V₁ for detection at a number of seismic receivers (126) along the line of profile. Likewise, velocity may refer to multiple velocities types, such as the two types of particle motions resulting from a seismic wave, i.e., velocity of the primary wave (P-wave) and a different velocity of the secondary wave (S-wave) through a particular medium. The seismic source (122) may be a seismic vibrator, such as one that uses a vibroseis technique, an air gun in the case of offshore seismic surveying, explosives, etc. The seismic receivers (126) may include geophones, hydrophones, accelerometers, and other sensing devices. Likewise, seismic receivers (126) may include single component sensors and/or multi-component sensors that measure pressure waves in multiple spatial axes.

As shown in FIG. 1, the seismic source (122) generates an air wave (128) formed by a portion of the emitted seismic energy, which travels above the earth's surface (130) to the seismic receivers (126). The seismic source (122) may also emit surface waves (132), which travel along the earth's surface (130). The speed of the surface waves (132), also called Rayleigh waves or ground roll, may correspond to a velocity typically slower than the velocity of a secondary wave. While the seismic surveying shown in FIG. 1 is a two-dimensional survey along a seismic profile along a longitudinal direction, other embodiments are contemplated, such as three-dimensional surveys.

Furthermore, subsurface layer (124) has a velocity V₁, while subsurface layer (140) has a velocity V₂. In words, different subsurface layers may correspond to different velocity values. In particular, a velocity may refer to the speed that a pressure wave travels through a medium, e.g., diving wave (146) that makes a curvilinear ray path (148) through subsurface layer (124). Velocity may depend on a particular medium's density and elasticity as well as various wave properties, such as the frequency of an emitted pressure wave. Where a velocity differs between two subsurface layers, this seismic impedance mismatch may result in a seismic reflection of a pressure wave. For example, FIG. 1 shows a pressure wave transmitted downwardly from the seismic source (122) to a subsurface interface (138), which becomes a reflected wave (136) transmitted upwardly in response to the seismic reflection. The seismic source (122) may also generate a direct wave (144) that travels directly from the seismic source (122) at the velocity V₁ through the subsurface layer (124) to the seismic receivers (126).

Turning to refracted pressure waves and diving pressure waves, the seismic source (122) may also generate a refracted wave (i.e., refracting wave (142)) that is refracted at the subsurface interface (138) and travels along the subsurface interface (138) for some distance as shown in FIG. 1 until traveling upwardly to the seismic receivers (126). As such, refracted pressure waves (e.g., refracted wave (142)) may be analyzed to map the subsurface layers (124, 140). For example, a refracted wave is a wave that a portion of ray path is along an interface of a reflector as show in refracting wave (142) in FIG. 1 (i.e., refraction exists only when V₂>V₁). On the other hand, a diving wave may be generated where velocities are gradually increasing with depth at a gradient (e.g., diving wave (146)), such that the diving wave may turn back along curvilinear ray path. Likewise, the apex of a diving wave may be consistent with a reflected seismic wave in a common midpoint (CMP) gather.

Furthermore, in analyzing seismic data acquired using the seismic surveying system (100), seismic wave propagation may be approximated using rays. For example, reflected waves (e.g., reflected wave (136)) and diving waves (e.g., diving wave (146)) may be scattered at the subsurface interface (138). In FIG. 1, for example, the diving wave B (146) may exhibit a ray path of a wide angle that resembles a reflected wave in order to map the subsurface. Using diving waves, for example, a velocity model for an underlying subsurface may be generated that describes the velocity of different regions in different subsurface layers. An initial velocity model may be generated by modeling the velocity structure of media in the subsurface using an inversion of seismic data, typically referred to as seismic inversion. In seismic inversion, a velocity model is iteratively updated until the velocity model and the seismic data have a minimal amount of mismatch, e.g., the solution of the velocity model converges to a minimum that satisfies a predetermined criterion. For example, the optimization algorithm may be “linearized” and while achieving a “minimum”, there may be no guarantee that it is a global minimum rather than a local minimum. Thus, it may be a simplification commonly adapted in solving inverse problems that works when a respective objective function is convex.

With respect to velocity models, a velocity model may map various subsurface layers based on velocities in different layer sub-regions (e.g., P-wave velocity, S-wave velocity, and various anisotropic effects in the sub-region). For example, a velocity model may be used with P-wave and S-wave arrival times and arrival directions to locate seismic events. Anisotropy effects may correspond to subsurface properties that cause pressure waves to be directionally dependent. Thus, seismic anisotropy may correspond to various parameters in geophysics that refers to variations of wave velocities based on direction of propagation. One or more anisotropic algorithms may be performed to determine anisotropic effects, such as an anisotropic ray-tracing location algorithm or algorithms that use deviated-well sonic logs, vertical seismic profiles (VSPs), and core measurements. Likewise, a velocity model may include various velocity boundaries that define regions where rock types changes, such as interfaces between different subsurface layers. In some embodiments, a velocity model is updated using one or more tomographic updates to adjust the velocity boundaries in the velocity model.

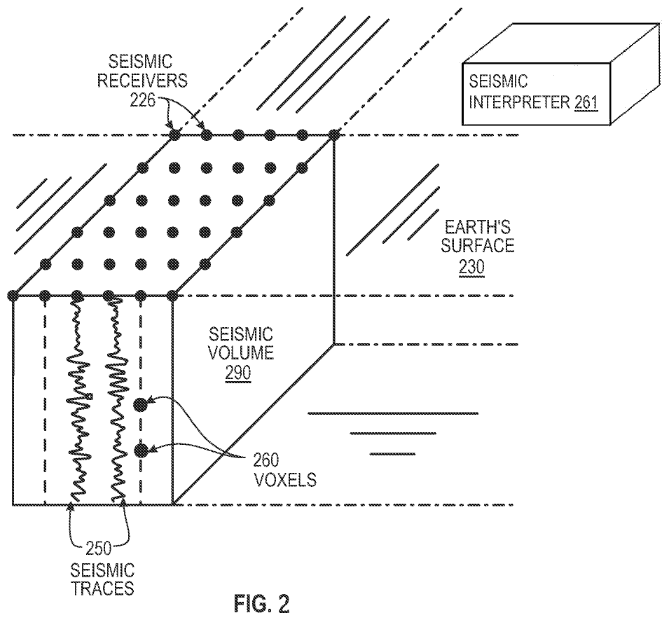

Turning to FIG. 2, FIG. 2 illustrates a system in accordance with one or more embodiments. As shown in FIG. 2, a seismic volume (290) is illustrated that includes various seismic traces (e.g., seismic traces (250)) acquired by various seismic receivers (e.g., seismic receivers (226)) disposed on the earth's surface (230). More specifically, a seismic volume (290) may be a cubic dataset of seismic traces. In particular, seismic data may have up to four spatial dimensions, one temporal dimension (i.e., related to the actual measurements stored in the traces), and possibly another temporal dimension related to time-lapse seismic surveys. Individual cubic cells within the seismic volume (290) may be referred to as voxels or volumetric pixels (e.g., voxels (260)). In particular, different portions of a seismic trace may correspond to various depth points within a volume of earth. To generate the seismic volume (290), a three-dimensional array of seismic receivers (226) are disposed along the earth's surface (230) and acquire seismic data in response to various pressure waves emitted by seismic sources. Within the voxels (260), statistics may be calculated on first break data that is assigned to a particular voxel to determine multimodal distributions of wave traveltimes and derive traveltime estimates (e.g., according to mean, median, mode, standard deviation, kurtosis, and other suitable statistical accuracy analytical measures) related to azimuthal sectors. First break data may describe the onset arrival of refracted waves or diving waves at the seismic receivers (226) as produced by a particular seismic source signal generation.

Seismic data may refer to raw time domain data acquired from a seismic survey (e.g., acquired seismic data may result in the seismic volume (290)). However, seismic data may also refer to data acquired over different periods of time, such as in cases where seismic surveys are repeated to obtain time-lapse data. Seismic data may also refer to various seismic attributes derived in response to processing acquired seismic data. Furthermore, in some contexts, seismic data may also refer to depth data or image data. Likewise, seismic data may also refer to processed data, e.g., using a seismic inversion operation, to generate a velocity model of a subterranean formation, or a migrated seismic image of a rock formation within the earth's surface. Seismic data may also be pre-processed data, e.g., arranging time domain data within a two-dimensional shot gather.

Furthermore, seismic data may include various spatial coordinates, such as (x,y) coordinates for individual shots and (x,y) coordinates for individual receivers. As such, seismic data may be grouped into common shot or common receiver gathers. In some embodiments, seismic data is grouped based on a common domain, such as common midpoint (i.e., Xmidpoint=(Xshot+Xrec)/2, where Xshot corresponds to a position of a shot point and Xrec corresponds to a position of a seismic receiver) and common offset (i.e., Xoffset=Xshot−Xrec).

In some embodiments, seismic data is processed to generate one or more seismic images. For example, seismic imaging may be performed using a process called migration. In some embodiments, migration may transform pre-processed shot gathers from a data domain to an image domain that corresponds to depth data. In the data domain, seismic events in a shot gather may represent seismic events in the subsurface that were recorded in a field survey. In the image domain, seismic events in a migrated shot gather may represent geological interfaces in the subsurface. Likewise, various types of migration algorithms may be used in seismic imaging. For example, one type of migration algorithm corresponds to reverse time migration. In reverse time migration, seismic gathers may be analyzed by: 1) forward modelling of a seismic wavefield via mathematical modelling starting with a synthetic seismic source wavelet and a velocity model; 2) backward propagating the seismic data via mathematical modelling using the same velocity model; 3) cross-correlating the seismic wavefield based on the results of forward modeling and backward propagating; and 4) applying an imaging condition during the cross-correlation to generate a seismic image at each time step. The imaging condition may determine how to form an actual image by estimating cross-correlation between the source wavefield with the receiver wavefield under the basic assumption that the source wavefield represents the down-going wave-field and the receiver wave-field the up-going wave-field.

In Kirchhoff and other migration methods, for example, the imaging condition may include a summation of contributions resulting from the input data traces after the traces have been spread along portions of various isochrones (e.g., using principles of constructive and destructive interference to form the image). For example, Kirchhoff migration function may be based on an integral form of a wave equation that corresponds to pressure wave displacement and a pressure wave velocity as function of three-dimensional space and time. As such, 3D prestack Kirchhoff depth migration may be characterized as the summation of various reflection amplitudes along diffraction traveltime curves to obtain the output seismic images. As such, Kirchhoff algorithms may preprocessing input seismic traces, determine traveltime tables for pressure waves using ray-tracing and a velocity model, and migrate these seismic traces. Besides Kirchhoff algorithms, other migration functions are also contemplated such as finite-difference migration, frequency-space migration, and frequency-wavenumber migration, and Stolt migration.

Keeping with migration functions, migration may also include a process of mapping seismic data onto an image that includes reflecting boundaries in the subsurface. Because migration techniques may rely on wavefield propagation estimates in the subsurface, poor velocity estimations may impact migration techniques that output one or more reflectivity maps in the depth domain. For example, poor velocity modeling may result in blurred images due to inaccurately mapping reflecting boundaries to the correct depths. Thus, wave equation migration velocity analysis (WEMVA) may be used to optimize modeling operators that are used to update one or more velocity models. In some embodiments, seismic full-waveform inversion (FWI) is used to determine velocity models by inverting a complete seismic dataset acquired for a particular geological region. FWI techniques may use local optimization approaches in cases where a reliable initial velocity model is available. The velocity model in FWI processes, unlike WEMVA techniques, may generate scattering in various modeling operators. FWI approaches may manage multiple scattering properly, but the FWI process may now experience reflecting errors based on high wavenumbers.

Furthermore, seismic data processing may include various seismic data functions that are performed using various process parameters and combinations of process parameter values. For example, a seismic interpreter may test different parameter values to obtain a desired result for further seismic processing. Depending on the seismic data processing algorithm, a result may be evaluated using different types of seismic data, such as directly on processed gathers, normal moveout corrected stacks of those gathers, or on migrated stacks using a migration function. Where structural information of the subsurface is being analyzed, migrated stacks of data may be used to evaluate seismic noise that may overlay various geological boundaries in the subsurface, such as surface multiples (e.g., strong secondary reflections that are detected by seismic receivers). As such, migrated images may be used to determine impact of noise removal processes, while the same noise removal processes may operate on gather data.

While seismic traces with zero offset are generally illustrated in FIG. 2, seismic traces may be stacked, migrated and/or used to generate an attribute volume derived from the underlying seismic traces. For example, an attribute volume may be a dataset where the seismic volume undergoes one or more processing techniques, such as amplitude-versus-offset (AVO) processing. In AVO processing, seismic data may be classified based on reflected amplitude variations due to the presence of hydrocarbon accumulations in a subsurface formation. With an AVO approach, seismic attributes of a subsurface interface may be determined from the dependence of the detected amplitude of seismic reflections on the angle of incidence of the seismic energy. This AVO processing may determine both a normal incidence coefficient of a seismic reflection, and/or a gradient component of the seismic reflection. Likewise, seismic data may be processed according to a pressure wave's apex. In particular, the apex may serve as a data gather point to sort first break picks for seismic data records or traces into offset bins based on the survey dimensional data (e.g., the x-y locations of the seismic receivers (226) on the earth surface (230)). The bins may include different numbers of traces and/or different coordinate dimensions.

Additionally, seismic imaging may be near the end of a seismic data workflow before an analysis by a seismic interpreter. The seismic interpreter may subsequently derive understanding of the subsurface geology from one or more final migrated images. In order to confirm whether a particular seismic data workflow accurately models the subsurface, a normal moveout (NMO) stack may be generated that includes various NMO gathers with amplitudes sampled from a common midpoint (CMP). In particular, a NMO correction may be a seismic imaging approximation based on calculating reflection traveltimes.

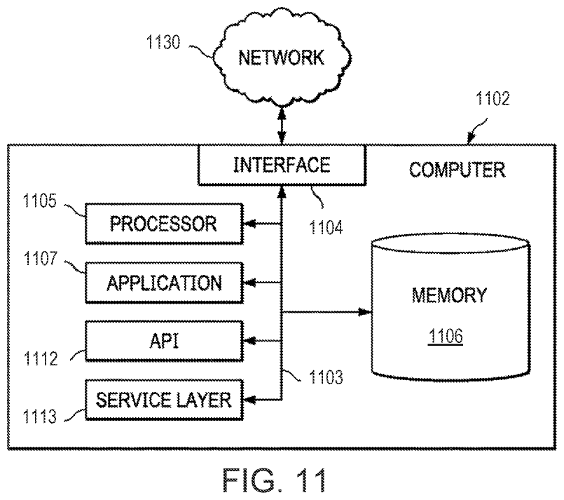

Turning to the seismic interpreter (261), a seismic interpreter (261) (also called a “seismic processing system”) may include hardware and/or software with functionality for storing the seismic volume (290), well logs, core sample data, and other data for seismic data processing, well data processing, and other data processes accordingly. In some embodiments, the seismic interpreter (261) may include a computer system that is similar to the computer (1102) described below with regard to FIG. 11 and the accompanying description. While a seismic interpreter may refer to one or more computer systems that are used for performing seismic data processing, the seismic interpreter may also refer to a human analyst performing seismic data processing in connection with a computer. While the seismic interpreter (261) is shown at a seismic surveying site, in some embodiments, the seismic interpreter (261) may be remote from a seismic surveying site.

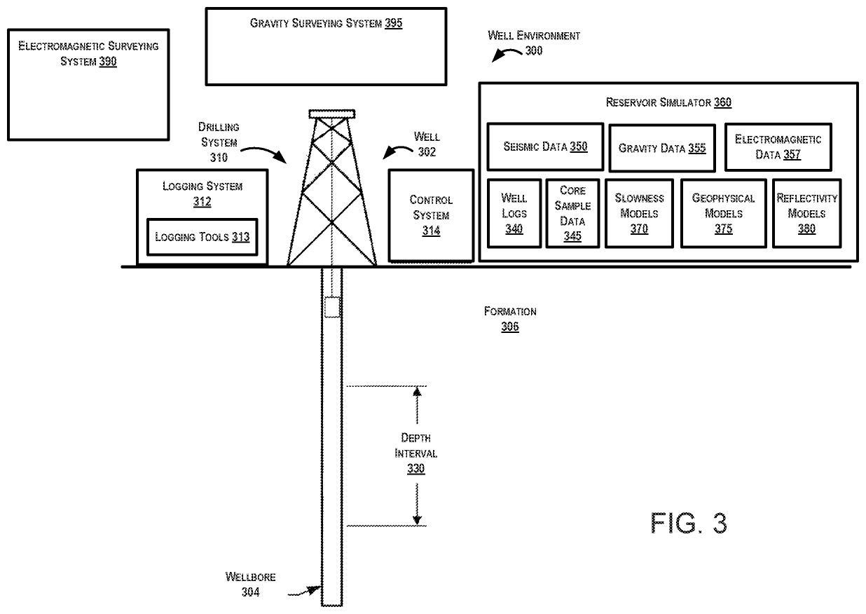

Turning to FIG. 3, FIG. 3 shows a schematic diagram in accordance with one or more embodiments. As shown, FIG. 3 illustrates a well environment (300) that may include a well (302) having a wellbore (304) extending into a formation (306). The wellbore (304) may include a bored hole that extends from the surface into a target zone of the formation (306), such as a reservoir. The formation (306) may include various formation characteristics of interest, such as formation porosity, formation permeability, resistivity, density, water saturation, and the like. Porosity may indicate how much space exists in a particular rock within an area of interest in the formation (306), where oil, gas, and/or water may be trapped. Permeability may indicate the ability of liquids and gases to flow through the rock within the area of interest. Resistivity may indicate how strongly rock and/or fluid within the formation (306) opposes the flow of electrical current. For example, resistivity may be indicative of the porosity of the formation (306) and the presence of hydrocarbons. More specifically, resistivity may be relatively low for a formation that has high porosity and a large amount of water, and resistivity may be relatively high for a formation that has low porosity or includes a large amount of hydrocarbons. Water saturation may indicate the fraction of water in a given pore space.

Keeping with FIG. 3, the well environment (300) may include reservoir simulator (360) and various well systems, such as a drilling system (310), a logging system (312), and a control system (314). The drilling system (310) may include a drill string, drill bit, a mud circulation system and/or the like for use in boring the wellbore (304) into the formation (306). Well systems may also include production systems that include production trees, production valves, downhole sensors, wellhead sensors, etc. The control system (314) may include hardware and/or software for managing drilling operations or production operations. For example, the control system (314) may include one or more programmable logic controllers (PLCs) that include hardware and/or software with functionality to control one or more processes performed by the drilling system (310). Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. A logging system may be similar to a control system with a specific focus on managing one or more logging tools.

Turning to the reservoir simulator (360), a reservoir simulator (360) may include hardware and/or software with functionality for storing and analyzing well logs (340), core sample data (345), seismic data (350), and/or other types of geophysical data, such as gravity data (355) and electromagnetic data (357) to generate and/or update one or more geophysical models (375), such as one or more slowness models (370). Geophysical models may include geochemical or geomechanical models that describe structural relationships and/or geophysical properties (e.g., porosity, permeability, electrical resistivity, a particle velocity of medium, etc.) within a particular geological region. Likewise, a geophysical model may identify one or more rock types associated with one or more geological regions (e.g., formation (306)). Examples of rock types may include one or more depositional rock types (e.g., where a geological region is based on a depositional environment), rock types that include similar diagenetic processes, rock types based on similar geological trends, and/or rock types based on similar reservoir properties. For example, a rock type may correspond to an irreducible water saturation, residual oil saturations, rock permeability, capillary pressure, maximum capillary pressure heights, relative permeabilities, and rock classes.

The logging system (312) may include one or more logging tools (313) for use in generating well logs of the formation (306). For example, a logging tool may be lowered into the wellbore (304) to acquire measurements as the tool traverses a depth interval (330) (e.g., a targeted reservoir section) of the wellbore (304). The plot of the logging measurements versus depth may be referred to as a “log” or “well log”. Well logs (340) may provide depth measurements of the well (304) that describe such reservoir characteristics as formation porosity, formation permeability, resistivity, water saturation, and the like. The resulting logging measurements may be stored and/or processed, for example, by the control system (314), to generate corresponding well logs for the well (302). A well log (340) may include, for example, a plot of a logging response time versus true vertical depth (TVD) across the depth interval (330) of the wellbore (304).

Turning to examples of logging techniques, multiple types of logging techniques are available for determining various reservoir characteristics (e.g., wireline logging, logging-while-drilling (LWD), and measurement-while-drilling (MWD)). For example, a nuclear magnetic resonance (NMR) analysis tool (e.g., an NMR logging tool or an NMR spectroscopy tool (380)) may measure the induced magnetic moment of hydrogen nuclei (i.e., protons) contained within the fluid-filled pore space of porous media (e.g., reservoir rocks). Thus, NMR data (e.g., NMR logs or NMR laboratory results) may measure the magnetic response of fluids present in the pore spaces of the reservoir rocks. In so doing, NMR data may measure both porosity and permeability, as well as the types of fluids present in the pore spaces. Thus, NMR logging may be a subcategory of electromagnetic logging that responds to the presence of hydrogen protons rather than a rock matrix. Because hydrogen protons may occur primarily in pore fluids, NMR data may directly or indirectly measure the volume, composition, viscosity, and distribution of pore fluids.

Various reservoir parameters may be determined by analyzing NMR data, such as T2 signal data. For example, NMR porosity (“MPHI”) may be determined by an integral of a saturated T2 distribution curve, which may be the area under a T2 signal curve. Likewise, a core sample may be centrifuged in order to repeat an NMR measurement to determine a value of the bulk volume irreducible of water (BVI) or amount of irreducible fluid in the core sample. A free fluid index (FFI) value may be the difference between total porosity and the BVI value. BVI values may correspond to the immovable or bound water in a formation, such as a capillary bound water. Thus, BVI may be a function of the pore-throat size distribution, where high threshold pressure due to smaller pore throats retains the fluids in the pores. BVI values may be determined using a cutoff-BVI (CBVI) model or a spectral BVI (SBVI) model, for example.

Turning to laboratory NMR analyses, one or more laboratory NMR analyses may be performed using one or more NMR spectroscopy tools. For example, an NMR spectroscopy tool may include various types of NMR spectrometers, where a NMR spectrometer may include a magnet module with one or more permanent magnets, a scan control system that includes various scan coils, and an oscilloscope for performing adjustments for signal amplitudes and phases. NMR spectroscopy tools may also include various multi-frequency antennas and probes. Likewise, NMR spectroscopy tools may also include automated laboratory apparatuses that perform sample preparation, automatic probe tuning, and data acquisition and NMR data processing. Using a laboratory, an NMR analysis may enable control of a testing environment (e.g., for managing saturating and desaturation operations of fluid within a core sample). Also, laboratory NMR measurements may be conducted at higher magnetic field than logging NMR techniques. Laboratory NMR analyses may also be non-destructive and provide spatial petrophysical properties (e.g., porosity and permeability) of a core sample.

Returning to logging tools, other types of logging techniques may also be used to analyze a geological region. For determining permeability, another type of logging may be used that is called spontaneous potential (SP) logging. SP logging may determine the permeabilities of rocks in the formation (306) by measuring the amount of electrical current generated between drilling fluid produced by the drilling system (310) and formation water that is held in pore spaces of the reservoir rock. Porous sandstones with high permeabilities may generate more electricity than impermeable shales. Thus, SP logs may be used to identify sandstones from shales. To determine porosity in the formation (306), the logging system (312) may measure the speed that acoustic waves travel through rocks in the formation (306). This type of logging may generate borehole compensated (BHC) logs, which are also called sonic logs. In general, sound waves may travel faster through high-density shales than through lower-density sandstones. Likewise, density logging may also determine porosity measurements by directly measuring the density of the rocks in the formation (306). Furthermore, neutron logging may determine porosity measurements by assuming that the reservoir pore spaces within the formation (306) are filled with either water or oil and then measuring the amount of hydrogen atoms (i.e., neutrons) in the pores. Other types of logging are also contemplated, such as resistivity logging and dielectric logging.

Reservoir characteristics may be determined using coring (e.g., physical extraction of rock specimens) to produce core samples for core analyses. Coring operations may include physically extracting a rock specimen from a region of interest within the wellbore (304) for detailed laboratory analysis. For example, when drilling an oil or gas well, a coring bit may cut core samples (or “cores” or “core specimens” or “core plugs”) from the formation (306) and bring the core samples to the surface, and these core specimens may be analyzed at the surface (e.g., in a laboratory) to determine various characteristics of the formation (306) at the location where the specimen was obtained.

Turning to various coring technique examples, conventional coring may include collecting a cylindrical specimen of rock from the wellbore (304) using a core bit, a core barrel, and a core catcher. The core bit may have a hole in its center that allows the core bit to drill around a central cylinder of rock. Subsequently, the resulting core specimen may be acquired by the core bit and disposed inside the core barrel. More specifically, the core barrel may include a special storage chamber within a coring tool for holding the core specimen. Furthermore, the core catcher may provide a grip to the bottom of a core and, as tension is applied to the drill string, the rock under the core breaks away from the undrilled formation below coring tool. Thus, the core catcher may retain the core specimen to avoid the core specimen falling through the bottom of the drill string.

In some embodiments, electromagnetic data (e.g., electromagnetic data (357)) is acquired using an electromagnetic surveying system (390). For example, an electromagnetic surveying system may use transient electromagnetic (TEM) sensing to map portions of a geological region. TEM sensing may be a geophysical technique that generates vertical resistivity measurements within a geological region by using electromagnetic signals that respond most strongly to conductive materials. In particular, TEM sensing may be a non-destructive method that uses a series of wire loops for transmitting and receiving electromagnetic signals within the ground. The series of wire loops may include a transmitter loop and multiple receiver coils to produce electromagnetic data, such as for generating a resistivity model of the subsurface. For illustration purposes, electric current flowing through a transmitter loop may produce one or more magnetic fields, which collapse to produce various electrical currents in the ground. Ground electric currents may thus produce a secondary magnetic field that is recorded by one or more receiver coils. In some embodiments, an electromagnetic surveying system is an airborne electromagnetic (AEM) system, such as a helicopter transient EM systems (HTEM) or a drone-mounted electromagnetic induction (EMI) sensor system. AEM systems may use various sensors, such as induction coil sensors, B-field sensors, and radio-electromagnetic sensors. Likewise, an electromagnetic surveying system may also be a marine system, such as a system that implements a marine controlled-source electromagnetic (CSEM) method. For example, a marine system may use distributed sensors, such as ocean bottom electro-magnetometers (OBEMs) and/or ocean bottom magnetometers (OBMs).

Furthermore, gravity data (e.g., gravity data (355)) may be acquired regarding variations in the Earth's gravity field using a gravity surveying system (395). In particular, marine and airborne gravimeters may be used to acquire gravity measurements, such as spring gravimeters and light pulse atom interferometry (LPAI) accelerometers. In an airborne surveying system, gravity data may obtain precise location measurements, airplane velocity vectors, and plane altitude for use in measuring gravity data. Furthermore, gravity sensing may use various gravity gradiometers that are instruments that measure gradients of a gravity field. In some embodiments, gravity gradiometers use pairs of accelerometers mounted on rotating disks to measure these gradients of the gravity field. Thus, a gravity gradient tensor may describe the spatial rate of change of gravitational acceleration at different locations with a magnitude and three-dimensional directions, such that the full gravity gradient may correspond to a 3×3 tensor. In some embodiments, the gravity surveying system determines gravity gradient data from a moving platform, such as in a helicopter tensor gravity gradient survey.

Keeping with gravity sensing, gravity sensors may also measure the difference between gravity gradients. For example, relative gravimeters may be used for rapid field measurements on the ground, at sea, in boreholes, and in aircraft vehicles. These relative gravimeters may include weights, springs, beams, and/or mirrors to measure small variations in the vertical gravity components through displacement of a responsive element from an equilibrium position. The change in displacements may be magnified using optical, mechanical, and/or electrical methods. For example, a LaCoste-Romberg gravimeter may use a mechanical ‘zero-length’ spring system, and a Scintrex CG-5 gravimeter may use a fused quartz spring system with electrostatic nulling. Gravity data may also correspond to absolute gravity measurements. For example, the absolute value of gravity at a site may be measured using a pendulum or laser interferometric measurements of a falling mass. In the case of a pendulum, absolute gravity measurements may be based on the relationship between the period of the pendulum and the acceleration of gravity.

Furthermore, gravity data may be used in hydrocarbon exploration to determine the density of different locations in the subsurface. In other words, gravity data may describe the rate of change of gravitational acceleration due to underlying rock properties. Using gravity data, various subsurface anomalies may be analyzed to determine hydrocarbon deposits, such as oil and gas.

Turning to geosteering, geosteering may be used to position the drill bit or drill string of the drilling system (310) relative to a boundary between different subsurface layers (e.g., overlying, underlying, and lateral layers of a pay zone) during drilling operations. In particular, measuring rock properties during drilling may provide the drilling system (310) with the ability to steer the drill bit in the direction of desired hydrocarbon concentrations. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling. Likewise, a well path of a wellbore (304) may be updated by the control system (314) using a geophysical model (e.g., one of the geophysical models (375)). For example, a control system (314) may communicate geosteering commands to the drilling system (310) based on well data updates that are further adjusted by the reservoir simulator (360) using a geophysical model. As such, the control system (314) may generate one or more control signals for drilling equipment (or a logging system may generate for logging equipment) based on an updated well path design and/or a geophysical model.

While the reservoir simulator (360) is shown at a well site in FIG. 3, in some embodiments, the reservoir simulator (360) or other components in FIG. 3 may be remote from a well site. In some embodiments, the reservoir simulator (360) is implemented as part of a software platform for the control system (314) or the seismic interpreter (261) in FIG. 2. The software platform may obtain data acquired by the drilling system (310), logging system (312), the electromagnetic surveying system (390), the seismic interpreter (261), and the gravity surveying system (395) as inputs, which may include multiple data types from multiple sources. The software platform may aggregate the data from these systems (310, 312, 390, 395, 261) in real time for rapid analysis. In some embodiments, the control system (314), the logging system (312), the reservoir simulator (360), the electromagnetic surveying system (390), the gravity surveying system (395), the seismic interpreter (261), and/or a user device coupled to one of these systems may include a computer system that is similar to the computer system (1102) described below with regard to FIG. 11 and the accompanying description.

While FIGS. 1, 2, and 3 show various configurations of components, other configurations may be used without departing from the scope of the disclosure. For example, various components in FIGS. 1, 2, and 3 may be combined to create a single component. As another example, the functionality performed by a single component may be performed by two or more components.

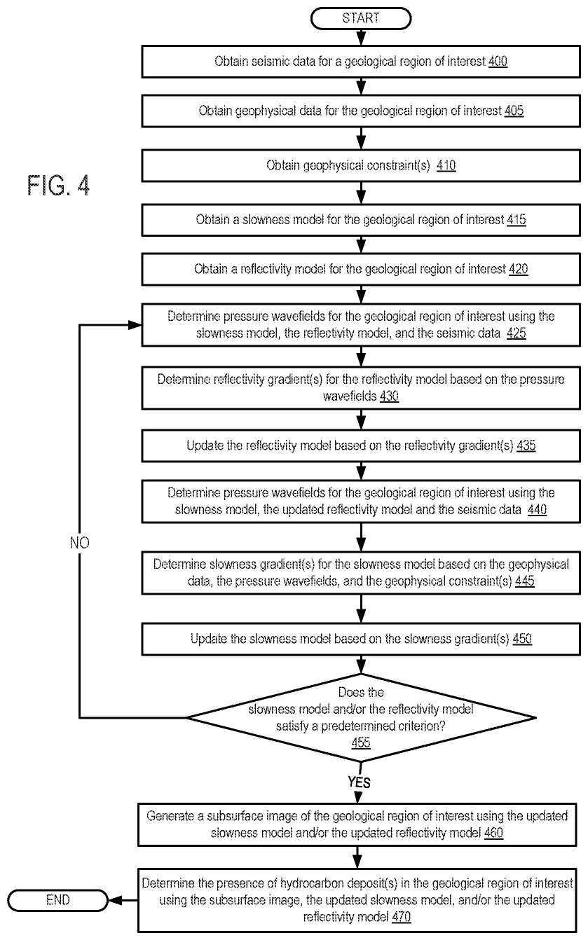

Turning to FIG. 4, FIG. 4 shows a flowchart in accordance with one or more embodiments. Specifically, FIG. 4 describes a general method for determining subsurface images using a joint inversion process. One or more blocks in FIG. 4 may be performed by one or more components (e.g., seismic interpreter (261) or reservoir simulator (360)) as described in FIGS. 1, 2, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, seismic data are obtained regarding a geological region of interest in accordance with one or more embodiments. A geological region of interest may be a portion of a geological area or volume that includes one or more formations of interest desired or selected for analysis, e.g., for determining location of hydrocarbons or reservoir development purposes. The seismic data may be similar to the seismic data described above in FIGS. 1, 2, and 3 and the accompanying description.

In Block 405, geophysical data are obtained for a geological region of interest in accordance with one or more embodiments. For example, geophysical data may include gravity data, electromagnetic data, well log data, core sample data, and other data types acquired using various geophysical surveying techniques.

In Block 410, one or more geophysical constraints are obtained in accordance with one or more embodiments. For example, different types of geophysical constraints may act as coupling operators for different data types in one or more joint inversion techniques. For example, a geophysical constraint may be used as an additional objective function that is minimized iteratively during a geophysical inversion process (e.g., a joint inversion process, such as a MpJMI process). Rather than applying a generic requirement to an updated model, such as structural smoothness of the final model, a geophysical constraint may be used to analyze a data misfit between synthetic geophysical data based on a particular model (e.g., an updated reflectivity model and an updated slowness model) with acquired geophysical data. Likewise, whether a geophysical constraint is satisfied by the current model may be used to determine an update for a velocity model or slowness model for a geological region of interest.

In some embodiments, various geophysical constraints include one or more rock-physics constraints. For example, a rock-physics constraint may link rock properties (e.g., porosity, permeability, and/or fluid saturation values acquired from well logs or core samples) to geophysical data, such as seismic data, gravity data, and/or electromagnetic data. In some embodiments, for example, electrical resistivity attributes based on an electromagnetic survey for a geological region is matched to particle velocity measurements of the same geological region from a seismic survey. In a particular iteration of an inversion process, synthetic resistivity values from electromagnetic data may be matched to synthetic resistivity values from seismic data or density data.

In some embodiments, various geophysical constraints include one or more structural constraints. In particular, structural similarity between a seismic model (e.g., a slowness model) and another geophysical model (e.g., a resistivity model) may be minimized using the cross product of various model gradients. For example, a structural constraint may be used in a cooperative joint inversion process, in which a stand-alone derived resistivity distribution provides a “reference model” through the cross-gradient minimization. Likewise, structural constraints may also be used in a simultaneous joint inversion scheme, in which seismic data and other geophysical data are simultaneously inverted based on a cross-gradient minimization constraint. In some embodiments, a structural constraint analyzes a cross-gradient misfit where a seismic model (e.g., slowness model, velocity model, or reflection model) is updated until the cross-gradient misfit is minimized. For example, a structural constraint may be based on a resistivity model using electromagnetic data from a helicopter transient electromagnetic (HTEM) survey of the geological region. Thus, resistivity data may be used as a regularization method to a seismic inversion process through a cross-gradient analysis. For example, faults, sharp formation boundaries, horsts, and graben-like structures may be better imaged by the resistivity distribution determined from electromagnetic data and used to match structural components in a seismic image. Likewise, structural constraints in a joint-inversion approach (e.g., seismic and electromagnetic data) may constrain the velocity inversion with higher resolution data (e.g., electromagnetic data and/or gravity data). As such, various high-resolution nonseismic surveying methods may complement seismic inversion effectively in the characterization of near surface region by filling the gaps and enhancing sensitivity to geologic features that are not properly sampled by seismic methods.

In some embodiments, various geophysical constraints include one or more clustering constraints. More specifically, a clustering constraint may analyze determined statistical petrophysical information using a statistical analysis, such as the mean and/or standard deviation of geological properties in a geological region. In particular, clustering functions may perform lithology classification based on inverted surface waves, P-wave velocity models, and S-wave velocity models through manual or automated identification of high-probability zones in a joint-probability density function. In particular, clusters may correspond to different geological objects in a deterministic inversion framework. For example, different geological objects may correspond to different lithologies that have distinct ranges of geophysical properties. By analyzing and processing the inverted geophysical property values, inference about subsurface lithologies and geological objects may be determined among statistically similar physical property values in order to group a respective geological unit into a cluster.

Keeping with clustering constraints, a cluster may include a group of geological objects that are similar based on statistical petrophysical information. The statistical distance between two geological objects within the same cluster may be smaller than the statistical distance between geological objects from different clusters. In a cluster analysis, geological objects may be classified according to different clusters. In some embodiments, a clustering constraint uses a fuzzy c-means (FCM) clustering technique in conjunction with a regularization scheme (e.g., classic Tikhonov regularization). The statistical information for the geophysical property values of different geologic units may be performed by FCM clustering in the parameter domain rather than the spatial domain as is typically done for seismic inversion. For example, a parameter domain for a gravity survey may correspond to various density values, where a particular element in this parameter domain may represent a possible density value for various subsurface rocks. In a joint inversion based on seismic data and gravity data, for example, the parameter domain for various geological units may include a pair of density and seismic velocity values. With FCM clustering, FCM clustering may be unsupervised classification technique that automatically groups a set of geological objects into multiple clusters. In some embodiments, an objective function for a clustering constraint is minimized when high membership values are assigned to geological objects close to cluster centers and low membership values are assigned to geological objects distant from cluster centers.

In Block 415, a slowness model is obtained for a geological region of interest in accordance with one or more embodiments. In particular, slowness may be the reciprocal of velocity. Thus, a slowness model may be based on a velocity model that describe various travel times of pressure waves based on the slowness of the physical medium. Slowness may also be referred to as interval transit time. In some embodiments, a velocity model is used in place of a slowness model in a joint inversion technique.

In Block 420, a reflectivity model is obtained for a geological region of interest in accordance with one or more embodiments. More specifically, a reflectivity model may describe various reflection coefficients at different locations in the geological region of interest. For example, a reflection coefficient may correspond to a ratio of amplitude of a reflected pressure wave to incident pressure wave, or how much seismic energy is reflected. When a pressure wave travels through the Earth encounters a geological interface between two materials with different acoustic impedances, some of the pressure wave energy may reflect off the interface and some pressure energy may refract through the interface. As such, a reflectivity model may identify various reflection boundaries throughout the geological region of interest.

In Block 425, various pressure wavefields are determined for a geological region of interest using a slowness model, a reflectivity model, and seismic data in accordance with one or more embodiments. In some embodiments, upgoing and downgoing pressure wavefields may be determined at one or more reflection interfaces using the slowness model and/or reflectivity model. More specifically, pressure wavefields may be determined in a similar manner as used in a full waveform inversion using forward modeling.

In Block 430, one or more reflectivity gradients are determined for a reflectivity model based on various pressure wavefields in accordance with one or more embodiments. In particular, various gradients may be determined based on one or more objective functions for updating a model, such as a reflectivity model and/or a slowness model. Thus, reflectivity gradients may be used to iteratively update reflection parameters to approach a global minimum. Various search methods may be used to determined reflectivity gradients, such as gradient descent or Newton's method. Moreover, reflectivity gradients may describes incremental changes as well as searching directions for various slopes at each iteration of the inversion process. Thus, reflectivity gradients may minimize an error function or loss function between acquired data (e.g., acquired seismic data) and synthetic data, such as the computed upgoing and downgoing pressure wavefields. Furthermore, reflectivity gradients may correspond to partial derivatives of an inversion technique's objective function for the reflectivity model.

In Block 435, a reflectivity model is updated based on one or more reflectivity gradients in accordance with one or more embodiments. In some embodiments, an inversion processes uses an iterative approach that updates the reflectivity model and the slowness model alternately in a single iteration. After determining the gradient direction of the reflectivity gradients, the reflectivity model may be updated accordingly.

In Block 440, pressure wavefields are determined for a geological region of interest using a slowness model, an updated reflectivity model, and seismic data in accordance with one or more embodiments. After updating the reflectivity model, pressure wavefields may be determined in a similar manner as Block 425.

In Block 445, one or more slowness gradients are determined for a slowness model based on geophysical data, various pressure wavefields, and one or more geophysical constraints in accordance with one or more embodiments. After determining pressure wavefields based on the updated reflectivity model and the current slowness model, slowness gradients may be determined for a particular optimization method, such as gradient descent or Newton's method. While reflectivity gradients may be based on synthetic seismic data, slowness gradients may also incorporate gradients based on rock-physics constraints, clustering constraints, and/or structural constraints as described above in Block 410 using geophysical data from Block 405. Slowness gradients may also be determined in a similar manner as reflectivity gradients as described in Block 430.

In some embodiments, for example, one or more geophysical models are used to determine slowness gradients for a corresponding geophysical constraint. In particular, a resistivity model (e.g., from electromagnetic data) and a density model (e.g., from gravity data) may be used to determine slowness gradients using a rock-physics constraint. Likewise, an electrical resistivity model may be used to determine cross-gradients with the slowness model for use in determining slowness gradients based on a structural constraint.

In Block 450, a slowness model is updated based on one or more slowness gradients in accordance with one or more embodiments. Using slowness gradients, a slowness model may be updated accordingly.

In Block 455, a determination is made whether a slowness model and/or a reflectivity model satisfy a predetermined criterion in accordance with one or more embodiments. For example, the predetermined criterion may correspond to whether the slowness model and/or the reflectivity model has converged based on analyzing the slowness gradients and/or reflectivity gradients. Likewise, predetermined criteria may include whether a difference between synthetic data (e.g., computed pressure wavefields) and acquired data, such as acquired seismic data, acquired electromagnetic data, and/or acquired gravity data, are within a predetermined amount of error. In some embodiments, the predetermined criterion corresponds to a predetermined number of optimization iterations of a joint inversion process. If the updated slowness model and/or the updated reflectivity model satisfy the predetermined criterion, the process may proceed to Block 460. If the updated slowness model and/or the updated reflectivity model fail to satisfy the predetermined criterion, the process may proceed to Block 425.

In Block 460, a subsurface image is generated for a geological region of interest using an updated slowness model and/or an updated reflectivity model in accordance with one or more embodiments. Various joint inversion techniques may recover a subsurface image based on seismic data and other geophysical data as well as a velocity model. In particular, some embodiments may be used for near surface velocity modeling, such as for land data seismic processing. In some embodiments, a subsurface image provides a spatial and depth illustration of a subsurface formation for various practical applications, such as predicting hydrocarbon deposits, predicting wellbore paths for geosteering, etc. After the geophysical data has been converted to geophysical attributes, an output image volume may then be post-processed and saved on a hard disk.

In Block 470, a presence of one or more hydrocarbon deposits are determined in a geological region of interest using a subsurface image, an updated slowness model and/or an updated reflectivity model in accordance with one or more embodiments.

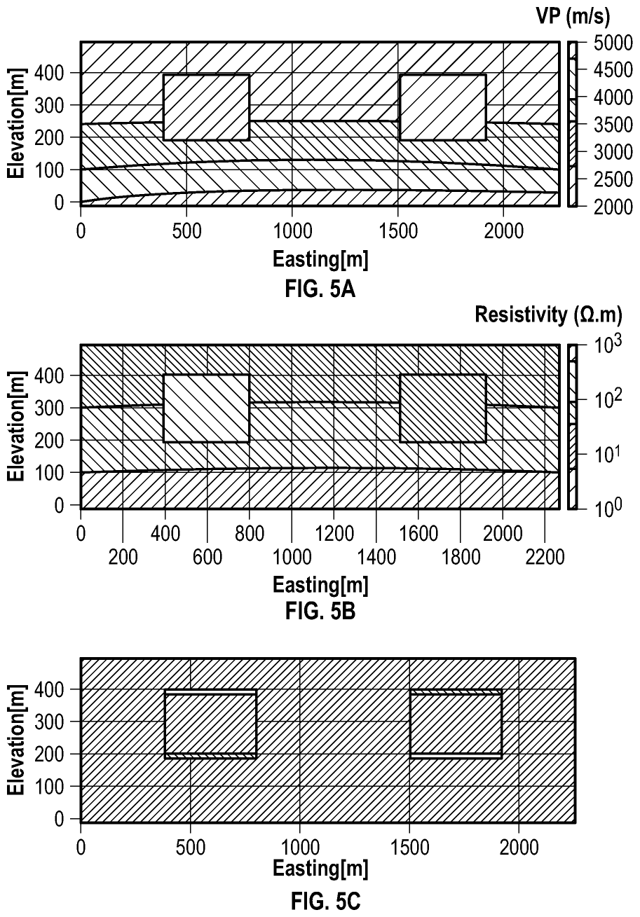

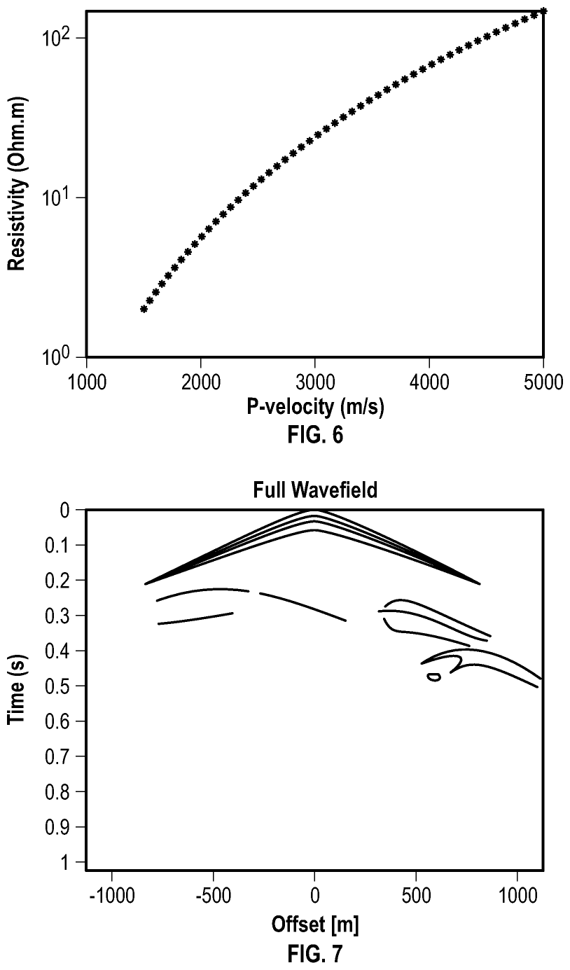

Turning to FIGS. 5A-5C, FIGS. 5A-5C show a multi-physics model that is used to generate synthetic data for an inversion process. FIG. 5A show a 2D representation of the velocity model for the first 500 m of the near-surface with a grid cell size of 10×10 m. The velocity model is generated with a background seismic P-wave velocity increasing linearly with depth from 2000 m/s to 5000 m/s. In particular, FIG. 5A shows a P-wave velocity model, FIG. 5B shows an electric resistivity model, and FIG. 5C shows a reflectivity model. The electric resistivity model in FIG. 5B is obtained from the velocity model using a rock physics relationship derived from a regression of velocity-resistivity cross-plots from well log data. In particular, the acquisition geometry includes 57 shots spaced by 30 m and receivers at all surface grid points. In some embodiments, for example, electric resistivity is expressed using the following equation:

$$ρ = {10}^{- 11} {v}^{3.56} \qquad Equation 11$$

where v is the P-wave velocity in m/s, and ρ is the electrical resistivity in Ωm, which is further illustrated in FIG. 6. In FIG. 6, a cross-plot is shown illustrating the power-law relation between electric resistivity and the P-wave velocity model that is used to generate the synthetic resistivity model for a rock-physics constraint. The seismic wavefield may be simulated using a Ricker wavelet with a source peak frequency of 10 Hz, a sampling interval of 4 ms, and a recording time of 1 second. In FIG. 7, a seismic shot-gather is shown that is generated using the seismic forward modeling presented in time-offset domains.

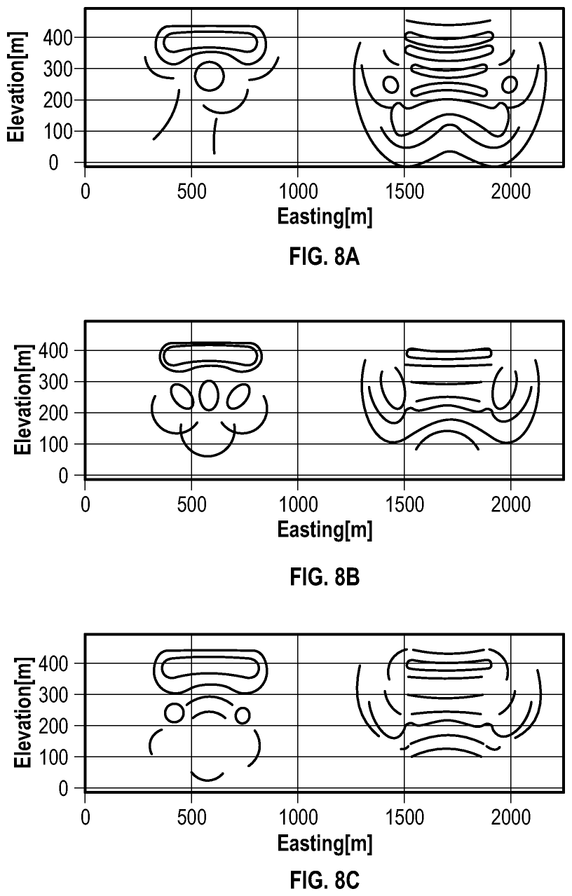

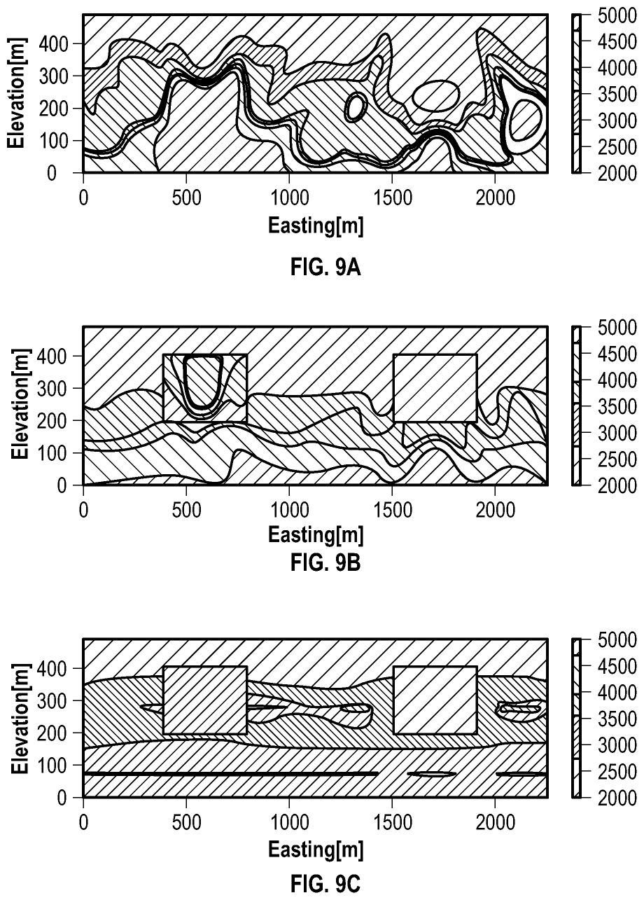

Turning to FIG. 7, FIG. 7 shows an example of acquired seismic data presented in the time-offset domain. Using an example inversion framework without geophysical constraints, the acquired seismic data is used to determine a velocity model in FIG. 9A and a reflectivity model in FIG. 8A in a single domain with a joint migration inversion process. For the initial models for the JMI process, a constant zero reflectivity model and a background velocity gradient of the true velocity model are used prior to determining a velocity model update or a reflectivity model update. The inversion process may applied using four frequency stages with a fixed minimum frequency of 5 Hz. The maximum frequency for the four stages is 10, 15, 20, and 25 Hz, respectively. The maximum number of iterations per stage was set at 20 iterations. The recovered reflectivity model in FIG. 8A and velocity model in FIG. 9A do not show the base of the high-velocity anomaly. To overcome this limitation, the inversion process is repeated using a rock-physics constraint based on an electric resistivity model. Based on the rock-physics constraint, a respective velocity model is generated in FIG. 8B and a respective reflectivity model in FIG. 9B. Likewise, a velocity model is generated in FIG. 9C and a reflectivity model is generated in FIG. 8C based on a clustering constraint. The effect of the clustering constraint is shown to clump the velocity property distribution around the clustering centers for the recovered velocity model.

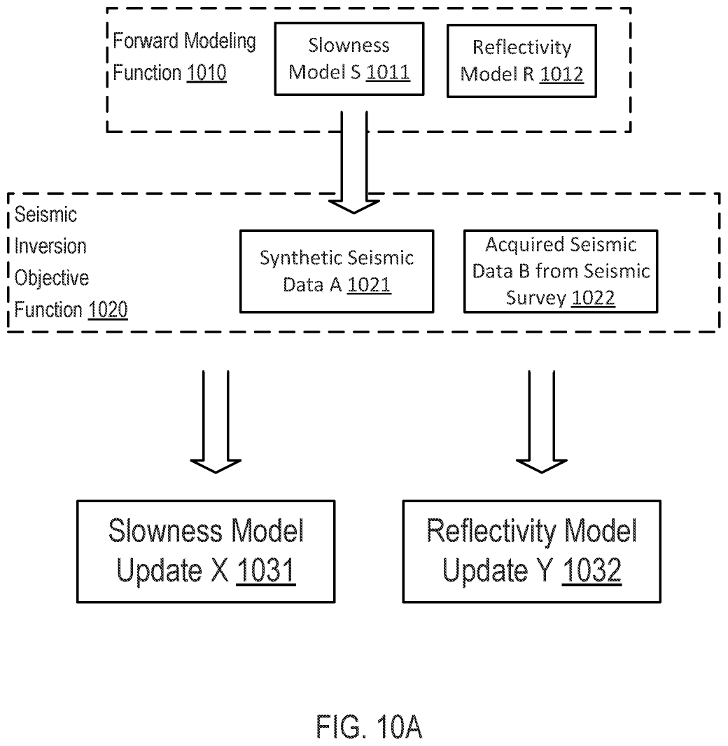

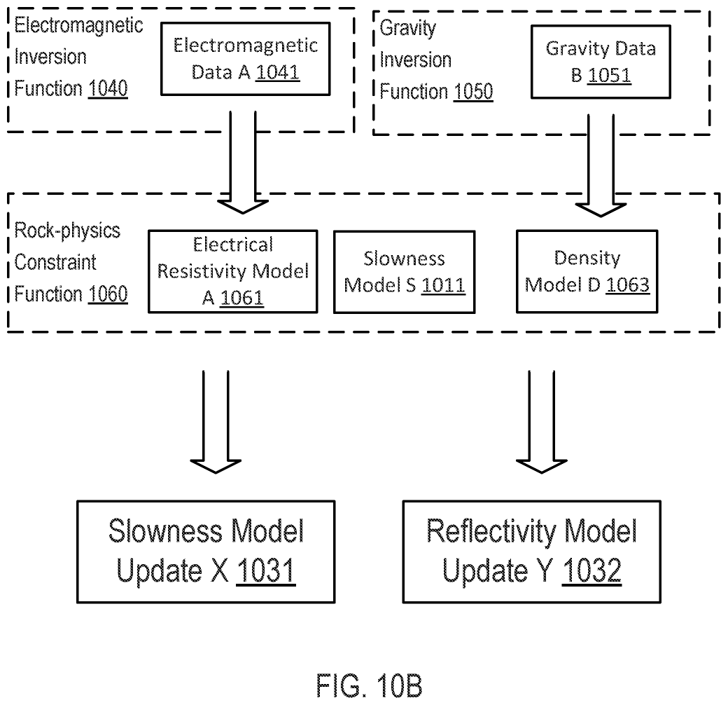

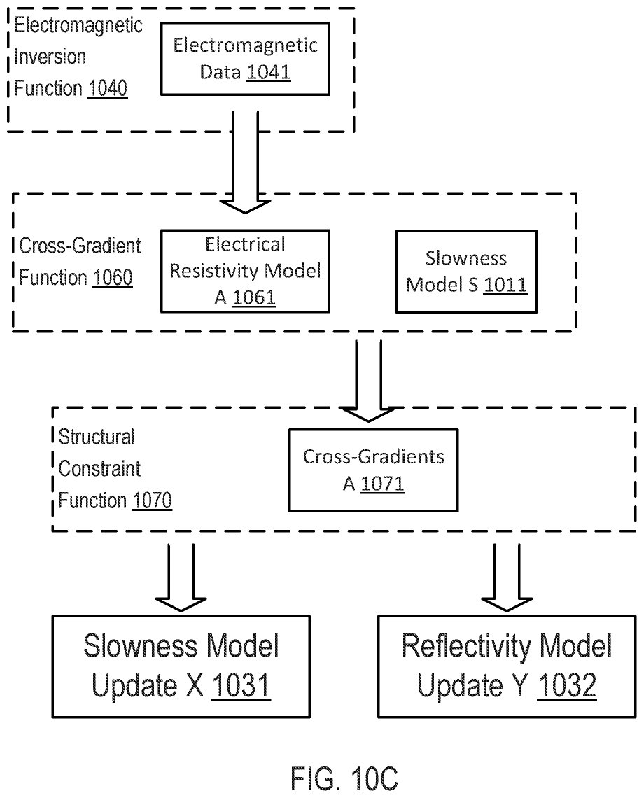

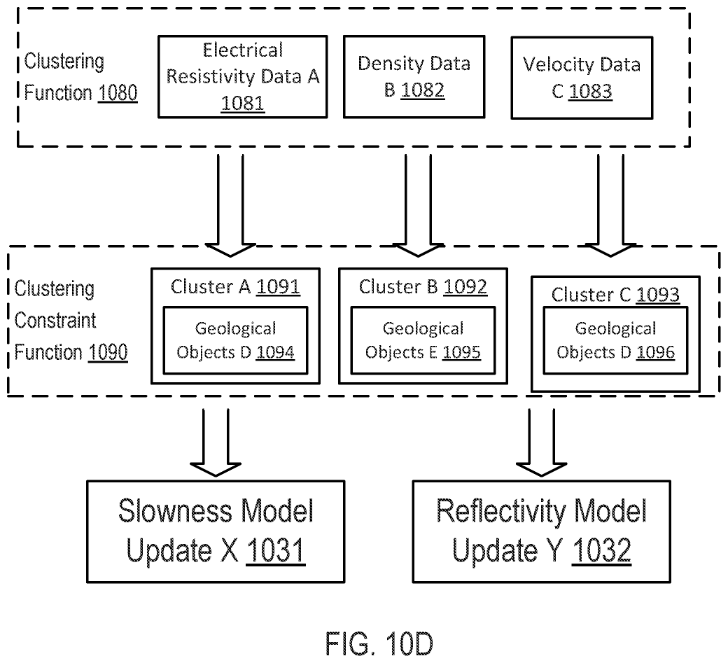

Turning to FIGS. 10A-10D, FIGS. 10A, 10B, 10C, and 10D provide an example of updating a slowness model and a reflectivity model using various geophysical constraints in accordance with one or more embodiments. The following example is for explanatory purposes only and not intended to limit the scope of the disclosed technology.

Turning to FIG. 10A, a reservoir simulator (not shown) applies a forward modeling function (1010) to a slowness model S (1011) and a reflectivity model R (1012) for a particular geological region in order to produce synthetic seismic data A (1021), which includes upgoing and downgoing pressure wavefields for the geological region. Using a seismic inversion objective function (1020), the reservoir simulator further analyzes the synthetic seismic data A (1021) and acquired seismic data B (1022) from a seismic survey for the geological region. In parallel with analyzing the synthetic seismic data A (1021) and the acquired seismic data B (1022), the reservoir simulator also uses several additional objective functions to analyze the slowness model S (1011) and the reflectivity model R (1012).

In FIG. 10B, the reservoir simulator applies an electromagnetic inversion function (1040) to electromagnetic data A (1041) from an electromagnetic survey of the geological region to determine an electrical resistivity model A (1061) for the geological region. The reservoir simulator further applies a gravity inversion function (1050) to gravity data B (1051) from a gravity survey of the geological region to determine a density model D (1063) for the geological region. Using the electrical resistivity model A (1061), the slowness model S (1011), and the density model D (1063), the reservoir simulator uses a rock-physics constraint function to determine whether to update the slowness model s (1011) and/or the reflectivity model R (1012).

In FIG. 10C, the reservoir simulator applies a cross-gradient function to the electrical resistivity model A (1061) and the slowness model S (1011) to determine cross-gradients A (1071) for input to a structural constraint function (1070). In particular, the structural constraint function (1070) determines using the cross-gradients A (1071) whether the near-surface region in the slowness model S (1011) accurately models various complex features, such as horsts and graben-like structures.

In FIG. 10D, the reservoir simulator applies a clustering function (1080) to electrical resistivity data A (1081), density data B (1082), velocity data C (1083) to determine various clusters organizing various geological objects. More specifically, the clustering function (1080) determines a cluster A (1091) that includes geological objects D (1094), cluster B (1092) that includes geological objects E (1095), and cluster C (1093) that includes geological objects D (1096). The reservoir simulator the analyzes the clusters (1091, 1092, 1093) using a clustering constraint function (1090), such as by analyzing the statistical distance between cluster centers of the clusters (1091, 1092, 1093).

Finally, based on the output of the seismic inversion function (1020), the rock-physics constraint function (1060), the structural constraint function (1070), and the clustering constraint function (1090), the reservoir simulator determines a slowness model update X (1031) and a reflectivity model update Y (1032), respectively. For example, the slowness model update X (1031) may include slowness gradients for updating the slowness model S (1011). On the other hand, the reflectivity model update Y (1032) may include reflectivity gradients for updating the reflectivity model R (1012).

### Computer System

Embodiments may be implemented on a computer system. FIG. 11 is a block diagram of a computer system used to provide computational functionalities associated with described algorithms, methods, functions, processes, flows, and procedures as described in the instant disclosure, according to an implementation. The illustrated computer (1102) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130) or cloud. In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) or cloud from a client application (for example, executing on another computer (1102)) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or other suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104 includes logic encoded in software or hardware (or a combination of software and hardware) and operable to communicate with the network (1130) or cloud. More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), each computer (1102) communicating over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

In some embodiments, the computer (1102) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining seismic data for a geological region of interest;
obtaining first geophysical data for the geological region of interest;
determining, by a computer processor, a first plurality of pressure wavefields using a slowness model and a reflectivity model;
determining, by the computer processor, a plurality of slowness gradients for the slowness model based on the first geophysical data, the first plurality of pressure wavefields, the seismic data, and a first geophysical constraint,
wherein the first geophysical constraint corresponds to an objective function that determines a misfit between the first geophysical data and the slowness model;
updating, by the computer processor, the slowness model using the plurality of slowness gradients to produce an updated slowness model; and
generating, by the computer processor and based on the updated slowness model and the reflectivity model, a subsurface image of the geological region of interest.

2. The method of claim 1, further comprising:
determining a second plurality of pressure wavefields using the updated slowness model and the reflectivity model;
determining a plurality of reflectivity gradients for the reflectivity model based on the second plurality of pressure wavefields and the seismic data; and
updating the reflectivity model using the plurality of reflectivity gradients to produce an updated reflectivity model.

3. The method of claim 1,
wherein the slowness model and the reflectivity model are alternately updated in an iterative process until the slowness model converges to a minimum.

4. The method of claim 1,
wherein the first plurality of pressure wavefields comprise a plurality of upgoing pressure wavefields and a plurality of downgoing pressure wavefields, and
wherein the first plurality of pressure wavefields are determined using a forward modeling function.

5. The method of claim 1, further comprising:
determining whether the slowness model satisfies a predetermined criterion,
wherein the predetermined criterion corresponds to a first objective function and a second objective function,
wherein the first objective function is based on a first misfit between the seismic data and synthetic seismic data corresponding to the first plurality of pressure wavefields,
wherein the second objective function is based on a second misfit between the first geophysical data and a plurality of geophysical properties associated with the slowness model, and
wherein the slowness model is updated in response to the slowness model failing to satisfy the predetermined criterion.

6. The method of claim 1,
wherein the first geophysical data comprises electromagnetic data and gravity data,
wherein the electromagnetic data is used to determine an electrical resistivity model for the geological region of interest,
wherein the gravity data is used to determine a density model for the geological region of interest, and
wherein the first geophysical constraint comprises a rock-physics constraint that provides an objective function based on a misfit between the slowness model, the electrical resistivity model, and the density model.

7. The method of claim 1, further comprising:
obtaining an electrical resistivity model for the geological region of interest using a portion of the first geophysical data,
wherein the portion of the first geophysical data comprises electromagnetic data this is acquired using a helicopter transient electromagnetic survey, and
wherein the first geophysical constraint is a structural constraint based on a cross-gradient function that is performed between the slowness model and the electrical resistivity model.

8. The method of claim 1, further comprising:
obtaining a second geophysical constraint, wherein the second geophysical constraint is a clustering constraint;
determining a plurality of geological objects based on second geophysical data for the geological region of interest;
determining a plurality of clusters in the geological region of interest based on a statistical analysis of the plurality of geological objects; and
determining whether the slowness model satisfies the clustering constraint based on the plurality of clusters,
wherein the slowness model is updated in response to the slowness model failing to satisfy the clustering constraint.

9. The method of claim 1,
wherein the plurality of slowness gradients are determined based on a gradient descent method.

10. The method of claim 1, further comprising:
determining a presence of hydrocarbons in the geological region of interest using the subsurface image.

11. The method of claim 1, further comprising:
acquiring, using a seismic surveying system, the seismic data regarding the geological region of interest.

12. A system, comprising:
a reservoir simulator comprising a computer processor, wherein the reservoir simulator is configured to perform a method comprising:
obtaining seismic data for a geological region of interest;
obtaining first geophysical data for the geological region of interest;
determining a first plurality of pressure wavefields using a slowness model and a reflectivity model;
determining a plurality of slowness gradients for the slowness model based on the first geophysical data, the first plurality of pressure wavefields, the seismic data, and a first geophysical constraint,
wherein the first geophysical constraint corresponds to an objective function that determines a misfit between the first geophysical data and the slowness model;
updating the slowness model using the plurality of slowness gradients to produce an updated slowness model; and
generating, based on the updated slowness model and the reflectivity model, a subsurface image of the geological region of interest.

13. The system of claim 12, wherein the method further comprises:
determining a second plurality of pressure wavefields using the updated slowness model and the reflectivity model;
determining a plurality of reflectivity gradients for the reflectivity model based on the second plurality of pressure wavefields and the seismic data; and
updating the reflectivity model using the plurality of reflectivity gradients to produce an updated reflectivity model.

14. The system of claim 12, wherein the method further comprises:
determining whether the slowness model satisfies a predetermined criterion,
wherein the predetermined criterion corresponds to a first objective function and a second objective function,
wherein the first objective function is based on a first misfit between the seismic data and synthetic seismic data corresponding to the first plurality of pressure wavefields,
wherein the second objective function is based on a second misfit between the first geophysical data and a plurality of geophysical properties associated with the slowness model, and
wherein the slowness model is updated in response to the slowness model failing to satisfy the predetermined criterion.

15. The system of claim 12,
wherein the first geophysical data comprises electromagnetic data and gravity data, and
wherein the electromagnetic data is used to determine an electrical resistivity model for the geological region of interest,
wherein the gravity data is used to determine a density model for the geological region of interest, and
wherein the first geophysical constraint comprises a rock-physics constraint that provides an objective function based on a misfit between the slowness model, the electrical resistivity model, and the density model.

16. The system of claim 12, wherein the method further comprises:
obtaining an electrical resistivity model for the geological region of interest using a portion of the first geophysical data,
wherein the portion of the first geophysical data comprises electromagnetic data this is acquired using a helicopter transient electromagnetic survey, and
wherein the first geophysical constraint is a structural constraint based on a cross-gradient function that is performed between the slowness model and the electrical resistivity model.

17. The system of claim 12, wherein the method further comprises:
obtaining a second geophysical constraint, wherein the second geophysical constraint is a clustering constraint;
determining a plurality of geological objects based on second geophysical data for the geological region of interest;
determining a plurality of clusters in the geological region of interest based on a statistical analysis of the plurality of geological objects; and
determining whether the slowness model satisfies the clustering constraint based on the plurality of clusters,
wherein the slowness model is updated in response to the slowness model failing to satisfy the clustering constraint.

18. The system of claim 12, further comprising:
a gravity surveying system comprising an aircraft device and a plurality of gravity gradiometers,
wherein the gravity surveying system is configured to generate gravity data for the geological region of interest,
wherein the gravity surveying system is coupled to the reservoir simulator, and
wherein the first geophysical data comprises the gravity data.

19. The system of claim 12, further comprising:
a logging system comprising a logging tool, wherein the logging system is coupled to a drilling system that drills a wellbore in the geological region of interest,
wherein the logging system is configured to generate well log data using the logging tool, and
wherein the first geophysical data comprises the well log data.

20. The system of claim 12, further comprising:
an electromagnetic surveying system comprising an aircraft device and a plurality of electromagnetic sensors,
wherein the electromagnetic surveying system is configured to generate electromagnetic data for the geological region of interest,
wherein the electromagnetic surveying system is coupled to the reservoir simulator, and
wherein the first geophysical data comprises the electromagnetic data.
